(19) United States
(12) Patent Application Publication
(10) Pub. No.: US 2024/0010831 A1
(43) Pub. Date: Jan. 11, 2024

(54) BOTTLE CAP COMPOSITION AND BOTTLE CAP

(71) Applicant: NAN YA PLASTICS CORPORATION, Taipei (TW)

(72) Inventors: Te-Chao Liao, TAIPEI (TW); Chun-Che Tsao, TAIPEI (TW); Yueh-Shin Liu, TAIPEI (TW)

(73) Assignee: NAN YA PLASTICS CORPORATION, TAIPEI (TW)

(21) Appl. No.: 17/938,938

(22) Filed: Sep. 7, 2022

(30) Foreign Application Priority Data
Jul. 7, 2022 (TW) 111125511

(51) Int. Cl. C08L 67/02

(52) U.S. Cl. CPC C08L 67/02; C08L 2203/10; C08L 2205/025; C08L 2205/06; C08L 2201/08; C08L 2205/03

(57) ABSTRACT

The disclosure provides a bottle cap composition and a bottle cap. The bottle cap composition includes polyethylene terephthalate (PET), a soft polyester material, a lubricant, and an antioxidant.

### CROSS-REFERENCE TO RELATED APPLICATION

This application claims the priority benefit of Taiwan application serial no. 111125511, filed on Jul. 7, 2022. The entirety of the above-mentioned patent application is hereby incorporated by reference herein and made a part of this specification.

### BACKGROUND

### Technical Field

The disclosure relates to a bottle cap composition and a bottle cap, and in particular to a bottle cap composition and a bottle cap having high toughness.

### Description of Related Art

In the future, the market will gradually lead to the trend of circular economy and plastic recycling, and under this market trend, the single materialization of products and the introduction of recycled materials are important goals for future development. The single materialization of products is to simplify the materials used in the products. When the products reach the service life, they can be directly recycled to avoid poor recyclability caused by the mixing of different materials, and to reduce the recycling process and carbon emissions. PET bottles are widely used packaging containers. In 2021, the global use of PET

bottles has reached 580 billion. Therefore, the recycling and reuse of PET bottles has become the focus of development in the market. The PET bottle is composed of a cap, a body, and a label. The bottle body is made of polyester material, and the cap material is HDPE or PP material. Since the cap of the bottle is not made of polyester, in the plastic bottle recycling process, it is necessary to remove the label with the de-labeling machine first, and then crush the whole bottle, and the crushed cap and PET bottle body are then sorted and recycled by the specific gravity floatation method. In addition to complicating the recycling process, the specific gravity flotation method will also cause waste of water resources.

Based on the above, a polyester bottle cap is developed to simplify the material of the bottle and simplify the recycling process, which is a goal that those skilled in the art are eager to develop.

### SUMMARY

The disclosure provides a bottle cap composition and a bottle cap, which may simplify the material of the bottle cap to simplify the recycling process.

The bottle cap composition of the disclosure includes polyethylene terephthalate (PET), a soft polyester material, a lubricant, and an antioxidant.

According to one embodiment of the disclosure, the polyethylene terephthalate (PET) has an intrinsic viscosity of 0.60 to 0.92.

According to one embodiment of the disclosure, the soft polyester material includes thermoplastic polyester elastomer (TPEE) or polybutylene adipate terephthalate (PBAT).

According to one embodiment of the disclosure, the soft polyester material has a hardness of 25 D to 55 D.

According to one embodiment of the disclosure, the soft polyester material is added in an amount of 10% by weight to 25% by weight based on a total weight of the bottle cap composition.

According to one embodiment of the disclosure, the lubricant includes stearates, polyethylene wax, siloxane modifier, or a fluorine-based resin.

According to one embodiment of the disclosure, the antioxidant includes a hindered phenolic antioxidant, a phenolic antioxidant, a mixed antioxidant, a phosphite-based antioxidant, a complex antioxidant, or a combination thereof.

According to one embodiment of the disclosure, the lubricant is added in an amount of 0.05% by weight to 1% by weight and the antioxidant is added in an amount of 0.1% by weight to 1% by weight based on a total weight of the bottle cap composition.

The bottle cap of the disclosure is made of the bottle cap composition.

Based on the above, the disclosure provides a bottle cap composition, and the produced polyester bottle cap may simplify the material of the bottle cap, so as to simplify the recycling process. In addition, the disclosure introduces mixing and modification through the soft polyester material, which may effectively improve the toughness of PET material and reduce hardness, thereby improving sealing performance.

To make the aforementioned more comprehensible, several accompanied with drawings are described in detail as follows.

### DESCRIPTION OF THE EMBODIMENTS

Hereinafter, embodiments of the disclosure will be described in detail. However, these embodiments are exemplary, and the disclosure is not limited thereto.

In this specification, a range represented by “one numerical value to another numerical value” is a general representation that avoids listing all the numerical values within the range. Accordingly, the recitation of a particular numerical range covers any numerical value within that numerical range as well as a smaller numerical range defined by any numerical value within that numerical range, as if the above-mentioned any numerical value and smaller numerical range are specified in this specification.

The disclosure provides a bottle cap composition including polyethylene terephthalate (PET), a soft polyester material, a lubricant, and an antioxidant.

According to this embodiment, an intrinsic viscosity of the polyethylene terephthalate (PET) is, for example, 0.60 to 0.92. The material of the polyethylene terephthalate (PET) may include virgin resin or a post consumer recycled resin (PCR resin). The source of the post consumer recycled resin may include recycled resin from PET bottle flakes, etc. to meet the requirement of introducing recycled materials, but the disclosure is not limited thereto.

According to this embodiment, the soft polyester material may include thermoplastic polyester elastomer (TPEE) or polybutylene adipate terephthalate (PBAT). A hardness of the soft polyester material is, for example, 25 D to 55 D, preferably 30 D to 40 D. Based on a total weight of the bottle cap composition, the soft polyester material is added in an amount of, for example, 10% by weight to 25% by weight, preferably 15% by weight to 20% by weight. By introducing the soft polyester material into the mixing and modification PET, a toughness of the PET material may be effectively improved and the hardness may be reduced, and the sealing performance may be improved, which may be used for bottle caps, and achieve the goal of simplification of the bottle material.

According to this embodiment, the lubricant may include stearates, polyethylene wax, siloxane modifier, or a fluorine-based resin. The lubricant is added in an amount of, for example, 0.05% by weight to 1% by weight based on a total weight of the bottle cap composition. By adding the lubricant, injection fluidity and releasability from a mold may be improved.

According to this embodiment, the antioxidant may include a hindered phenolic antioxidant, a phenolic antioxidant, a mixed antioxidant, a phosphite-based antioxidant, a complex antioxidant, or a combination thereof. The antioxidant is added in an amount of, for example, 0.1% by weight to 1% by weight based on a total weight of the bottle cap composition. By adding the antioxidant, the heat resistance and processability of the material may be improved.

The disclosure also provides a bottle cap made from the bottle cap composition described above.

Hereinafter, the above-mentioned bottle cap composition and the bottle cap of the disclosure will be described in detail with reference to experimental examples. However, the following experimental examples are not intended to limit the disclosure.

### Experimental Example

In order to prove that the bottle cap composition according to the disclosure may be used to form a polyester bottle cap with better toughness and hardness, the following experimental example was carried out.

### Instrumental Analysis

Specific gravity: density of a substance relative to density of pure water at 4° C. Tested according to ASTM D792 standard.

Impact strength (Izod notched impact strength): The test was performed according to ASTM D256 standard. The obtained value indicates the total energy that the test sample can withstand when it breaks. A greater value indicates that the test sample can withstand greater impact strength (or the resistance strength of the test sample). The unit is kg-cm/cm.

Tensile strength: The test was performed according to ASTM D638 standard. The obtained value indicates the total energy that the test sample can withstand against tensile deformation. A greater value indicates that the test sample can withstand greater tensile strength. The unit is MPa.

Flexural modulus: The test was performed according to ASTM D790 standard. The obtained value indicates the total energy that the test sample can withstand against flexural deformation. A greater value indicates that the test sample has greater rigidity. The unit is MPa.

Rockwell hardness: The test was performed according to ASTM D785 standard. It is an index to determine the hardness value based on the depth of indentation plastic deformation. A greater value indicates that the material has greater hardness.

Heat distortion temperature (HDT): The test was performed according to ASTM D648 standard. It is a parameter expressing the relationship between the heat and distortion of the test sample, and an index to measure the heat resistance of the polymer. During the test, a certain load is applied to the polymer, and the temperature is increased at a certain rate, and the temperature corresponding to the specified distortion is reached.

### Analysis of Properties of Bottle Cap

The component ratios and test results of the bottle caps of Examples 1 to 3 and Comparative Example 1-1, Comparative Example 1-2 and Comparative Example 2 are listed in Table 1 below. In Table 1, 3802 is the type of PET polyester resin for plastic bottles of NAN YA PLASTICS CORPORATION, and its intrinsic viscosity is 0.8. As can be seen from Table 1, compared with the current bottle cap materials of Comparative Example 1-1, Comparative Example 1-2, and the unmodified PET of Comparative Example 2, the impact resistance of the unmodified PET of Comparative Example 2 is not good, and hardness and rigidity are too high. Through the Examples 1 to 3 where the soft polyester material is introduced into the mixing and modification PET, the toughness of the PET material may be effectively improved and the hardness may be reduced, thereby improving the sealing performance, which may be used for bottle caps to improve the shortcomings of unmodified PET materials that have poor impact resistance, high hardness and rigidity resulting in poor sealing.

TABLE 1

| | Comparative | | Comparative | Comparative | | | |
|---|---|---|---|---|---|---|---|
| | Example 1-1 | | Example 1-2 | Example 2 | Example 1 | Example 2 | Example 3 |
| Material | HDPE | | PP | Unmodified | 15 wt % | 3802 + 20% | 20% |
| ratio | (type 8040C) | | (type 6231) | PET | hardness 40D, | PBAT | hardness 30D |
| | | | | | TPEE + 3802 | | TPEE + 3802 |
| Mechanical | Specific | 0.96 | 0.9 | 1.34 | 1.29 | 1.32 | 1.27 |
| properties | gravity | | | | | | |
| | Impact | 7 | 3.1 | 3.5 | 9.4 | 7.8 | 7.4 |
| | strength | | | | | | |
| | (kg − cm/cm) | | | | | | |
| | Tensile | 28 | 37 | 58 | 53 | 639 | 38 |
| | strength | | | | | | |
| | (MPa) | | | | | | |
| | Flexural | 1200 | 1720 | 2560 | 2220 | 1380 | 1660 |
| | modulus | | | | | | |
| | (MPa) | | | | | | |
| | Rockwell | 65 | 100 | 106 | 88 | 68 | 72 |
| | hardness | | | | | | |
| | HDT (° C.) | 80 | 109 | 75 | 81 | 72 | — |
| | Shrinkage | 1.8 | 1.5 | 0.8 | 0.9 | 0.9 | 1.0 |
| | rate | | | | | | |

To sum up, the disclosure provides a bottle cap composition, and the produced polyester bottle cap may simplify the material of the bottle cap, so as to simplify the recycling process. That is, the floatation sorting steps may be omitted and the waste of water resources may be avoided, thereby realizing the trend of circular economy and plastic recycling. In addition, the disclosure introduces mixing and modification through the soft polyester material, which may effectively improve the toughness of PET material and reduce hardness, thereby improving sealing performance, and may be used for bottle caps to improve the shortcomings of unmodified PET materials that have poor impact resistance, high hardness and rigidity resulting in poor sealing.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. A bottle cap composition comprising:
polyethylene terephthalate (PET);
a soft polyester material;
a lubricant; and
an antioxidant.

2. The bottle cap composition according to claim 1, wherein the polyethylene terephthalate (PET) has an intrinsic viscosity of 0.60 to 0.92.

3. The bottle cap composition according to claim 1, wherein the soft polyester material comprises thermoplastic polyester elastomer (TPEE) or polybutylene adipate terephthalate (PBAT).

4. The bottle cap composition according to claim 1, wherein the soft polyester material has a hardness of 25 D to 55 D.

5. The bottle cap composition according to claim 1, wherein the soft polyester material is added in an amount of 10% by weight to 25% by weight based on a total weight of the bottle cap composition.

6. The bottle cap composition according to claim 1, wherein the lubricant comprises stearates, polyethylene wax, siloxane modifier, or a fluorine-based resin.

7. The bottle cap composition according to claim 1, wherein the antioxidant comprises a hindered phenolic antioxidant, a phenolic antioxidant, a mixed antioxidant, a phosphite-based antioxidant, a complex antioxidant, or a combination thereof.

8. The bottle cap composition according to claim 1, wherein the lubricant is added in an amount of 0.05% by weight to 1% by weight and the antioxidant is added in an amount of 0.1% by weight to 1% by weight based on a total weight of the bottle cap composition.

9. A bottle cap made of the bottle cap composition according to claim 1.
